(19) United States
(12) Patent Application Publication
(10) Pub. No.: US 2005/0207874 A1
(43) Pub. Date: Sep. 22, 2005

(54) Device for coating hollow bodies, in particular plastic bottles, that has a high vaccum region and sluice

(76) Inventors: Klaus Michael, Gelnhausen (DE); Jurgen Henrich, Limeshain (DE); Thomas Gebele, Freigericht (DE); Helmut Drimm, Darmstadt (DE)

Correspondence Address: NEEDLE & ROSENBERG, P.C., SUITE 1000, 999 PEACHTREE STREET, ATLANTA, GA, 30309-3915, US

(21) Appl. No.: 10/848,370

(22) Filed: May 18, 2004

(30) Foreign Application Priority Data
Mar. 16, 2004 (DE) 102004012663.1

(51) Int. Cl. B65G 1/00

(52) U.S. Cl. 414/217

(57) ABSTRACT

Plastic bottles as well as other hollow bodies are given thin functional layers by means of high vacuum coating devices. The relevant process takes place in high vacuum. The bottles to be coated as well as the coated bottles are inserted into a high vacuum chamber (20) through a sluice, which consists of carrousel drum unit. Due to the difference of pressure in the atmosphere and the high vacuum chamber, carrousel within the drum suffers a displacement or tipping, which makes the sealing of the carrousel with respect to the drum difficult. Hence the invention proposes a sluice system consisting of two sluices (23, 25) of the mentioned type, which are connected with one another by means of an intermediate vacuum chamber (22). It is thus achieved that the load due to the pressure on each drum (3) decreases, so that each sluice (23, 25) functions with lesser tendency to develop faults.

The present application claims priority to German Application No. 10 2004 012 663.1, filed Mar. 16, 2004, which application is incorporated herein fully by this reference.

### BACKGROUND OF THE INVENTION

1. Field of the Invention

The invention relates to a device for coating hollow bodies, in particular plastic bottles, whereby the device has a high vacuum region and a sluice for charging the high vacuum chamber, together with the hollow body to be coated, and the sluice consists of a drum with a rotatable carrousel within that has several recesses for receiving the hollow body in its outer side, and whereby, above and below the recesses, the carrousel is provided with two circumscribing annular seals, and spanned between the annular seals there are longitudinal seals between the recesses, and whereby the drum has two mutually opposite holes in its surface shell through which the hollow body can be inserted into the recesses or taken out.

2. Description of the Related Art

A similar device had been described, for example, in DE 198 07 031 A1. In case of that device, there are several aspiration holes connected to a pump system. With the progress of the rotation of the carrousel, the recesses pass by the aspiration holes and are thus stepwise evacuated. This has proved to be useful on a small scale. However, problems arise, if, in order to increase the throughput, either the speed of rotation of the carrousel must be increased, or a carrousel with higher diameter must be employed. Due to the difference in the atmospheric pressure and the pressure in the coating chamber (high vacuum region), a force oriented in the direction of the high vacuum region acts on the carrousel.

This has the consequence that the carrousel takes a slightly eccentric trajectory with respect to the drum, and thereby the width of the annular slit, that must be sealed, between the surface shell of the carrousel and the inner wall of the drum varies over the perimeter of the drum, so that the strain requirements of the annular seals increase. The problem becomes still bigger, if the carrousel is supported by the bearings only on one side. In which case, tipping takes place at the same time, forcing the annular seal to undergo a swaying motion, which leads to its rapid wear.

Hence, the invention is based on the problem of realizing a sluice system, which functions durably without requiring maintenance, which means, in particular, that the seals are subjected to less wear. Further, despite its simple design, the seal must provide durable and good sealing.

To solve this problem, in this invention a device, according to the generic term of the claim 1, is devised, in which the sluice system consists of a first and a second sluice of the type mentioned in the generic term, and contains an intermediate chamber, in which the pressure lies between the atmospheric pressure and the pressure in the high vacuum chamber, whereby the first sluice connects the intermediate vacuum chamber with the atmosphere and the second sluice connects the intermediate vacuum chamber with the high vacuum chamber.

As a result of this measure, the pressure difference between the two sluices is reduced, so that even with one-sided bearing of the carrousel, no or only slight tipping of the carrousel axis is expected. Hence, over the perimeter of the carrousel, the slit remains same, which can therefore be sealed by simple means.

Above all, labyrinth seals can be employed in the second sluice, because with that the intermediate vacuum chamber can be kept small, so that no large mass of air that can stream into the high vacuum chamber is present there.

As a rule, the intermediate chamber can also be constructed as a process chamber in which the pre- and post-treatments of the bodies that are to be coated in the high vacuum chamber can take place.

For loading or unloading of the charge from and into the sluice, transfer devices, the so-called transfer stars are employed.

In the following, the invention is explained in detail by means of an illustrative model. Following figures show, in that context:

### BRIEF DESCRIPTION OF THE DRAWINGS

FIG. 1 Cross-section view of a sluice;

FIG. 2 Longitudinal section of the sluice in FIG. 1

FIG. 3 Longitudinal section of carrousel wall;

FIG. 4 An alternative design of the annular seal;

FIG. 5 Schematic presentation of a two-step sluice system with an intermediate vacuum chamber;

FIG. 6 Schematic presentation of the sluice system, in which the intermediate vacuum chamber is designed as a process chamber.

### DETAILED DESCRIPTION OF THE PREFERRED EMBODIMENTS

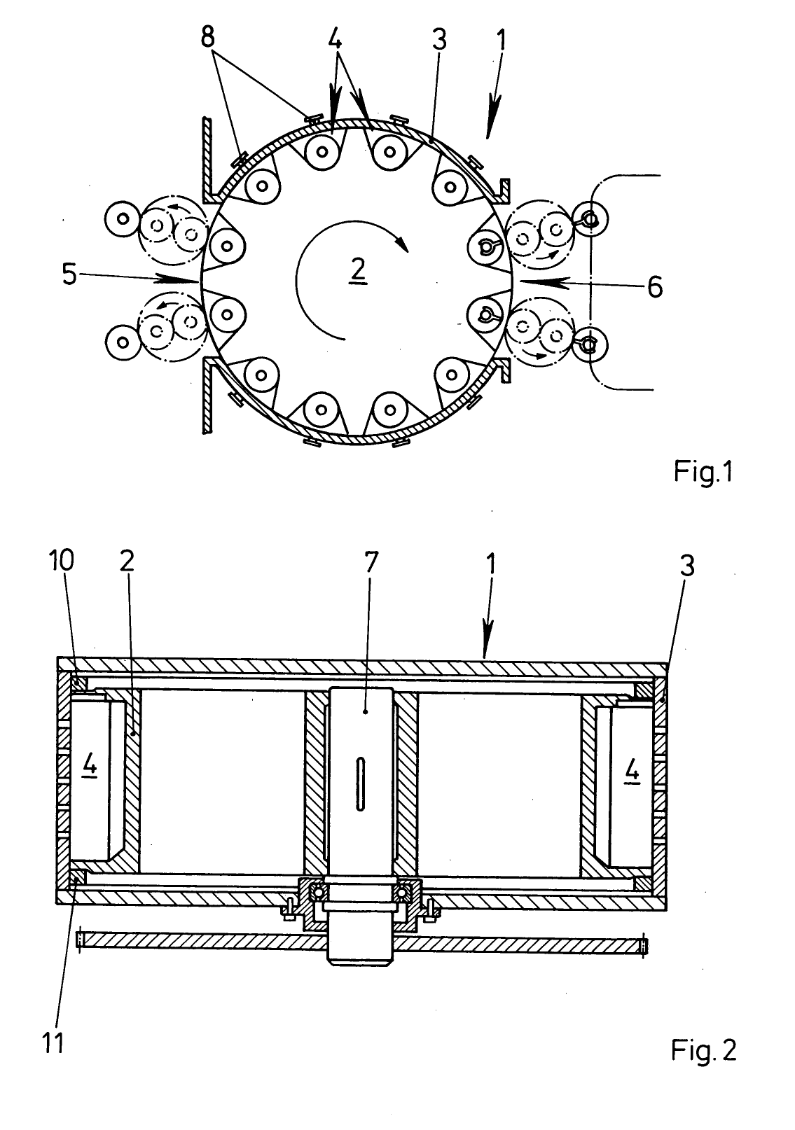

FIG. 1 will be considered first. A sluice 1 consists of carrousel 2, which rotates in drum 3, whereby the outer surface of the carrousel 2 is closely adjacent to the inner side of the drum 3. In the surface shell of the cylinder type carrousel 2, there are several recesses 4, side by side, in the form of conic grooves, leading up the carrousel. These recesses 4 serve the purpose of receiving the hollow bodies, that is, for example, the bottles.

The drum has two mutually opposite openings 5, 6 for charging. They are so wide that it is possible each time to access two recesses 4. Hence a bottle can be taken out from each hole 5, 6 as well as a bottle can be introduced into the sluice 1.

Along the perimeter, there are aspiration holes 8, through which stepwise evacuation of the recesses 4 between both the openings for charging 5, 6 is possible. Hence, from that viewpoint, it is a multistage sluice.

As it can be seen in FIG. 2, carrousel 2 is supported by bearings on the rotation axis 7, which is rotatably supported on the bottom of the drum 3. Carrousel 2 has two circumscribing annular seals 10, 11 along its upper and upper sides, which seal the annular slit between the carrousel 2 and the inner wall of the surface shell of the drum 3. Further, between the recesses 4, there are longitudinal seals 12 (not shown in FIG. 2), which also bridge the annular slit between carrousel 2 and drum 3.

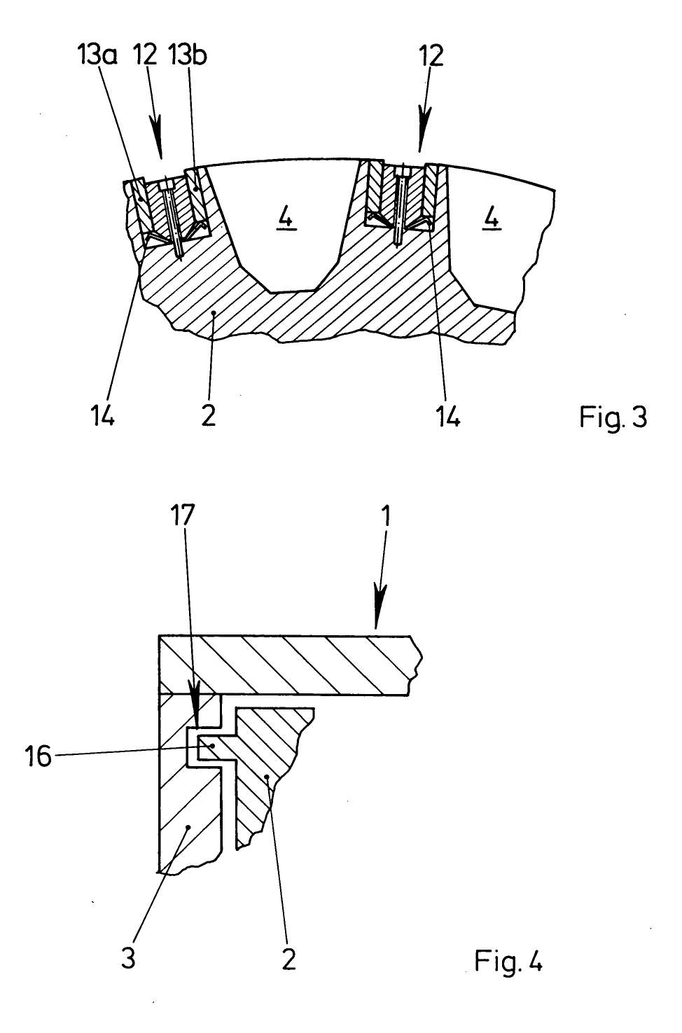

In FIG. 3, the design of such a longitudinal seal (12) is shown. Each consists of a lip pair 13a, 13b, which is spanned to the outside by means of the spring 14.

Since the longitudinal seal 12 leads, at both ends, up to the annular seals 10, 11, each recess 4 is encircled on all sides.

As it can be seen in FIG. 2, the annular seals 10, 11 can be simple rubber gaskets, that lie in the corresponding grooves in the carrousel 2 and with the surface projecting from the adjacent groove adjacent to the inner side of the drum 3. Such a seal can also be designed with a labyrinth seal.

FIG. 4 shows a cross section of such a labyrinth. In the simplest case, it consists of a groove 17 in drum 3, into which a gangway 16, moving radially outwards cuts in. The measurements are selected in such a fashion that, considering all the tolerances, a slit between the gangway 16 and the bottom or the turns of the groove remains.

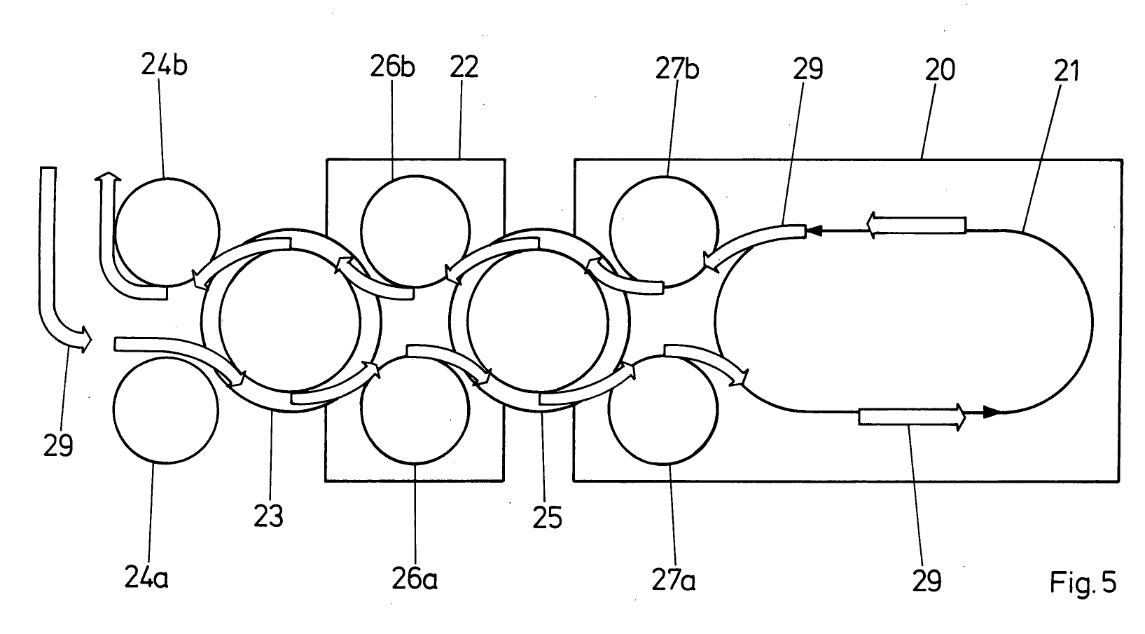

Such a sluice 1 can thus be used in a double design for making a two-stage sluice system according to FIG. 5.

The device consists of a high vacuum chamber 20, which functions as a process chamber and in which the corresponding process systems 21 for coating plastic bottles are provided. Before this high vacuum chamber 20, there is an intermediate vacuum chamber 22. A first sluice 23, built as in FIGS. 1-3, is provided for loading the charge in this chamber. For the loading and unloading of the carrousel 2, two transfer devices 24a, 24b are provided on the outside.

Between the intermediate vacuum chamber 22 and the high vacuum chamber 20, there is a second sluice 25, which is also built according to the FIGS. 1-3, in which, especially, a labyrinth seal as in FIG. 4 can be provided. For transfer of the bottles from the first sluice 23 to the second sluice 25, two further transfer devices 26a, 26b are provided.

To exchange the bottles between the second sluice 25 and the process system 21, transfer devices 27a, 27b are also provided in the high vacuum chamber.

Thus, during the sluicing into the high vacuum chamber 20 as well as during sluicing out, the bottles pass through both the sluices 23, 25. The path of the bottles through the device is indicated by the arrows 29.

This somewhat larger contrivance is compensated by a less fault prone operation of the sluices 23, 25, because both the sluices 23, 25 are exposed to less intense forces due to the splitting of the pressure difference.

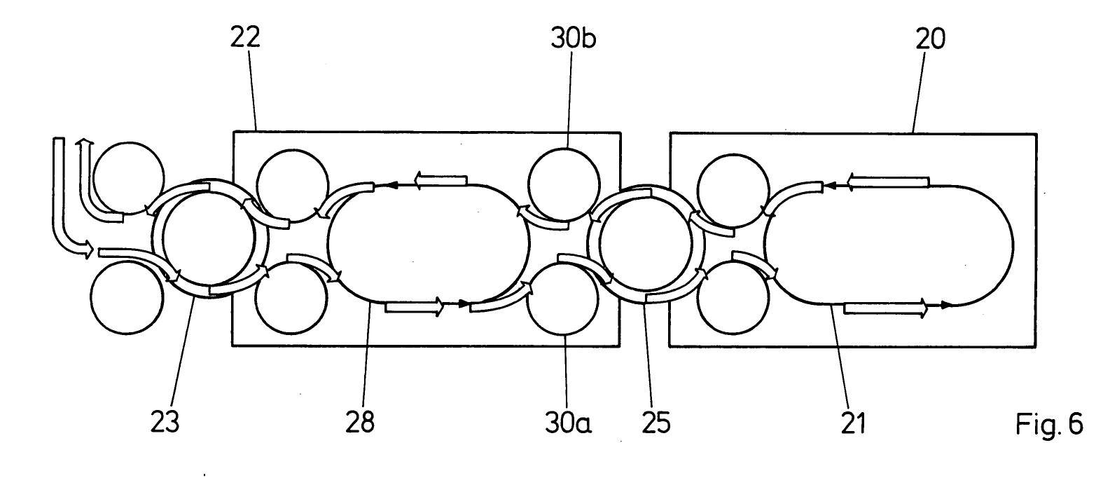

The device shown in FIG. 6 corresponds to FIG. 5, with the difference that here the intermediate vacuum chamber 22 also functions as a process chamber in which an additional process system 28 is installed. This necessitates an additional pair of transfer devices 30a, 30b. Here the pressure is higher than that in the high vacuum chamber 20, because obviously here only those processes can take place which require vacuum but not necessarily high vacuum.

1. The device for coating hollow bodies, in particular plastic bottles, with a high vacuum region and a sluice for charging the high vacuum chamber, together with the hollow body to be coated, whereby the sluice consists of a drum and a rotatable carrousel within, which has several recesses for receiving the hollow body, whereby, above and below the recesses, the carrousel is provided with two circumscribing annular seals, and spanned between the annular seals there are longitudinal seals between the recesses, and whereby the drum has two mutually opposite holes in its surface shell, through which the hollow body can be inserted into the recesses or taken out, characterized in that, it contains a sluice system consisting of a first (23) and a second sluice (25), of aforementioned type, as well as an intermediate chamber, such that the pressure in it lies between the atmospheric pressure and the pressure in the high vacuum chamber (20) and that the first sluice (23) connects the intermediate vacuum chamber (22) with the atmosphere and the second sluice (25) connects the intermediate vacuum chamber (22) with the high vacuum chamber (20).

2. Device according to claim 1, characterized in that the carrousel 2 has one-sided bearings support.

3. Device according to claim 1, characterized in that the annular seals (10, 11) of the second sluice (25) are designed using labyrinth seals.

4. Device according to claim 1, characterized in that the intermediate vacuum chamber (22) functions as a process chamber.
